(19) United States
(12) Patent Application Publication
(10) Pub. No.: US 2019/0125075 A1
(43) Pub. Date: May 2, 2019

(54) WORKSTATION COMPRISING WORK SURFACE COMPRISING INTEGRATED DISPLAY PROTECTED BY STRENGTHENED GLASS LAMINATE COVER

(71) Applicant: CORNING INCORPORATED, CORNING, NY (US)

(72) Inventor: Mark J Soulliere, Corning, NY (US)

(21) Appl. No.: 16/096,045

(22) PCT Filed: Apr. 24, 2017
(86) PCT No.: PCT/US2017/029083

§ 371 Date: Oct. 24, 2018

Related U.S. Application Data
(60) Provisional application No. 62/327,079, filed on Apr. 25, 2016.

(51) Int. Cl. A47B 21/04; B32B 17/06; A47B 13/12; G06F 1/16; G06F 1/20; B01L 9/02

(52) U.S. Cl. CPC A47B 21/04; B32B 17/06; A47B 13/12; G06F 1/1601; G06F 1/20; B32B 7/12; B32B 2307/30; B32B 2479/00; B32B 2457/20; B32B 2571/00; B01L 9/02

(57) ABSTRACT

A workstation including: a horizontally aligned work surface comprising a recess formed in an upper surface thereof; a display disposed in the recess and configured to display images; and a strengthened glass laminate cover disposed on the work surface, covering the display, and having a thickness of 6 mm or less. The cover includes a glass core layer, and glass cladding layers fused directly to opposing sides of the core layer.

This application claims the benefit of priority to U.S. Application No. 62/327,079, filed Apr. 25, 2016, the content of which is incorporated herein by reference in its entirety.

### BACKGROUND

### 1. Field

This disclosure relates to workstations including horizontally aligned work surfaces including integrated displays protected by strengthened fused glass laminate covers that are resistant to heat and corrosive materials.

### 2. Technical Background

Conventional laboratory workstations include electronic test equipment (oscilloscopes, spectrum analyzers, etc.) that typically include embedded processing units coupled with a display device having limited display characteristics. Such equipment generally occupies a significant amount of work space, limiting the utility of conventional laboratory workstations. This is particularly true when a larger display is necessary to simultaneously generate and arrange alternate views to compare information from multiple tests and equipment functions. One solution for electronic, biological, or chemical laboratory bench settings is to employ a personal computer with a vertical display unit positioned above the lab bench surface or integrated into the bench in a vertical orientation.

In some instances, users may find it more ergonomic to have a display unit disposed horizontally on the workstation work surface. Such, a display device may be incorporated into a work surface in a horizontal position. However, a laboratory bench work surface may be exposed to chemicals, heat, impacts, and other harsh conditions that can easily damage such an integrated display device, unless the display device is properly protected by a transparent cover.

However, conventional transparent covers are formed of materials that lack adequate damage resistance, workability, and/or visibility. Accordingly there is a need for a laboratory bench including a horizontally embedded display device that is protected with a transparent cover having improved characteristics.

### SUMMARY

Disclosed herein are workstations having integrated displays protected by strengthened fused glass laminate covers.

According to various embodiments, provided is a workstation including: a horizontally aligned work surface comprising a recess formed in an upper surface thereof; a display disposed in the recess and configured to display images; and a strengthened glass laminate cover disposed on the work surface, covering the display, and having a thickness of 6 mm or less. The cover comprises a glass core layer, and glass cladding layers fused directly to opposing sides of the core layer.

According to various embodiments, provided is a workstation including a horizontally aligned work surface having a recess formed in an upper surface thereof; one or more legs configured to support the work surface; a display horizontally disposed in the recess and configured to display images; and a cover disposed over the display and flush with the upper surface of the work surface, the cover including a strengthened fused glass laminate and having a thickness of 6 mm or less. The cover comprises a glass core layer, and glass cladding layers fused directly to opposing sides of the core layer.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 illustrates an exemplary glass fusion process according to various embodiments of the present disclosure.

FIG. 2 is a sectional view of an exemplary glass laminate, according to various embodiments of the present disclosure.

FIG. 3A is a perspective view of an exemplary workstation, according to various embodiments of the present disclosure.

FIGS. 3B-3D are sectional views taken along line A of FIG. 3A, according to various embodiments of the present disclosure.

FIG. 4 is a perspective view of an exemplary workstation, according to various embodiments of the present disclosure.

FIG. 5 is a perspective view of an exemplary workstation, according to various embodiments of the present disclosure.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; that is, the phrase “A or B” means “A, B, or both A and B”. Exclusive “or” is designated herein by terms such as “either A or B”, for example. In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately described. The scope of the subject matter describe herein is not limited to the specific values recited when defining a range. Herein, the terms “dad” and “core” are relative terms. In addition, the phrase “substantially horizontally aligned” refers to horizontal alignments, as well as alignments within +/−45 degrees, +/−30 degrees, +/−15 degrees, or +/−5 degrees of horizontal when positioned for use. In addition, the phrase “glass” may be used to refer to a glass material a glass-ceramic material, or a combination thereof.

A work surface of a workstation, such as a laboratory or industrial workstation, may often encounter high temperatures, corrosive materials, impacts, and/or abrasion in a laboratory setting. Accordingly, a display embedded in such a work surface should be protected by a cover that is resistant to such damage, while at the same time being substantially distortion free.

Conventional plastic and glass materials may be used to form a transparent protective cover for a display embedded in a horizontally aligned workstation work surface. However, such conventional materials may have corresponding drawbacks and/or limitations. For example, transparent plastic materials, such as polycarbonates, may provide adequate initial transparency. However, such plastic materials generally provide poor scratch, crack, corrosion, and heat resistance, resulting in reduced transparency (e.g. image transmission) over time.

Tempered soda lime glass may provide suitable crack and scratch resistance. However, soda lime glass generally is cut to size before being tempered. During the tempering process, the size and/or shape of the glass may change. As a result, it may be difficult to produce a tempered soda lime glass protective cover that meets tight tolerances needed to snugly embed such a protective cover in a work surface.

Further, tempered soda lime glass may present optical issues. For example, tempered soda lime glass may distort an image provided by an underlying display, due to the “tempering wave”, which is particularly problematic if the image from the display device is polarized. In addition, tempered soda lime glass may absorb a substantial amount of light (e.g., may have a relatively low transparency), and may exhibit off axis parallax distortion due to the glass thickness required for adequate strength. Further, the strength of tempered soda lime glass may be locally reduced over time, due to heat relaxation, such as from repetitive heating and cooling cycles produced by hot lab ware.

Borosilicate glass may have a lower coefficient of thermal expansion and superior shock resistance, as compared to soda lime glass. However, for higher scratch and impact resistance, thermal tempering may be desirable. Tempered borosilicate glass also may exhibit more lateral cracking than tempered soda lime glass. Tempered borosilicate glass also may suffer from the issues identified above related to dimensional changes during tempering, low transparency, optical distortion, and heating-related strength reduction.

Ion exchanged glass provides scratch resistance and toughness. However, ion exchanged glass may suffer from the above issues related to strength reduction due to heat relaxation.

According to various embodiments, provided is a bench including a work surface, a horizontally aligned display embedded in the work surface, and a laminate glass covering the display. In some embodiments, the laminate glass may be a fused laminate glass formed by a laminate fusion draw process.

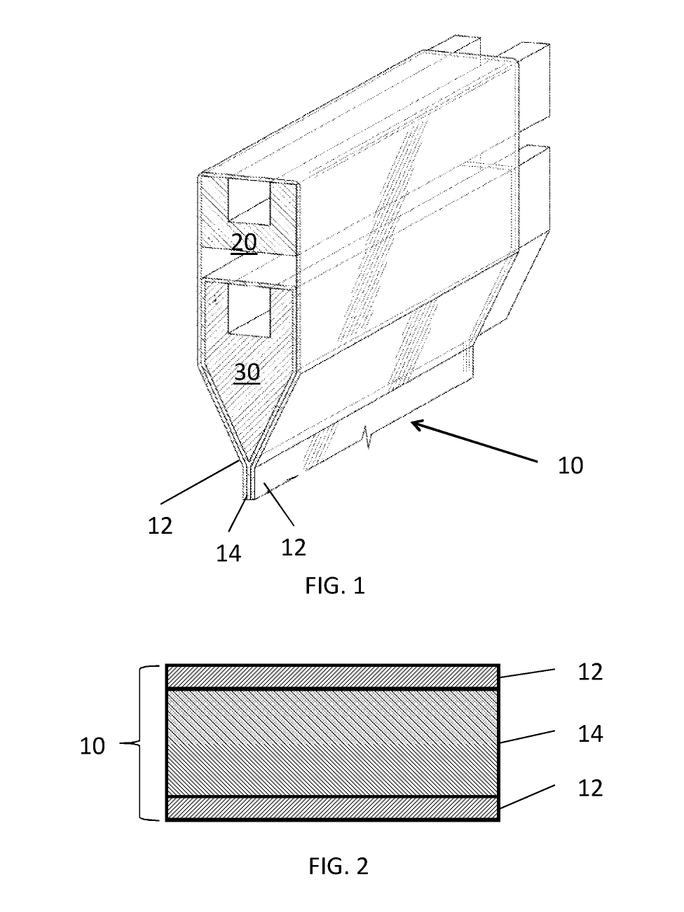

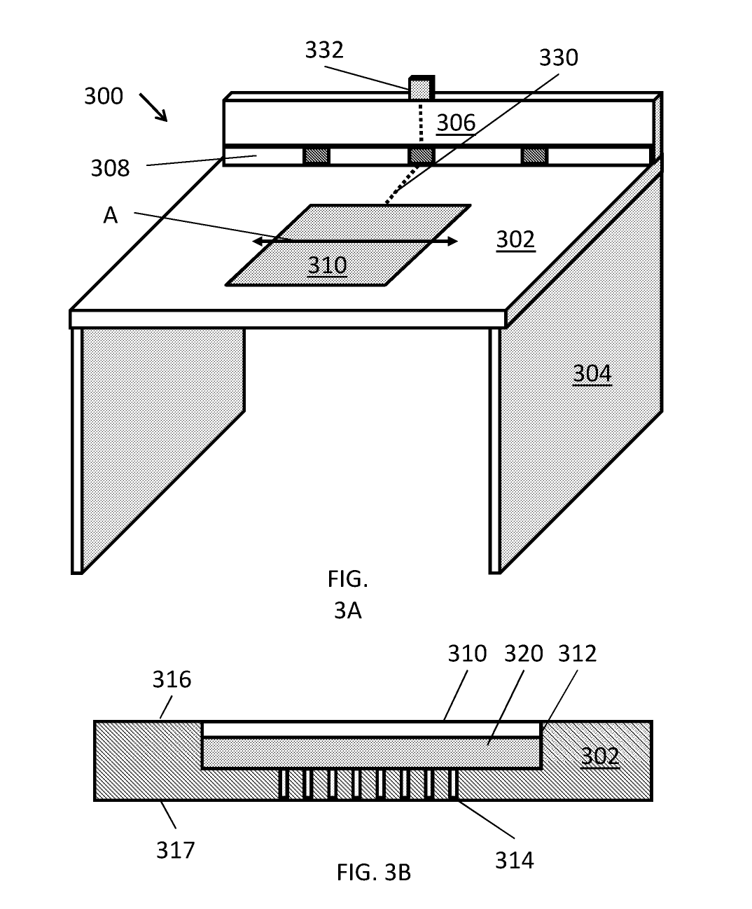

FIG. 1 is a cross-sectional view that illustrates the laminate fusion draw process, and FIG. 2 is a cross-sectional view of a glass laminate 10 that may be formed using the process of FIG. 1, according to various embodiments of the present disclosure. The details of the process of FIG. 1 can be readily gleaned from available teachings in the art including, for example, U.S. Pat. Nos. 4,214,886, 7,207,193, 7,414,001, 7,430,880, 7,681,414, 7,685,840, 7,818,980, International Patent Pub. No. 2004094321, and U.S. Patent Application Pub. No. 2009/0217705. However, the present disclosure is not limited to any particular method of forming a glass laminate. In various embodiments, a glass laminate may be formed using a fusion draw process, a slot draw process, a float process, or another suitable forming process.

Referring to FIGS. 1 and 2, in the laminate fusion process, molten outer layer glass overflows from an upper isopipe 20 and merges with core glass at the weir level of a bottom isopipe 30. The two sides merge and a three-layer flat glass laminate 10 comprising a core layer 14 and cladding layers 12 forms at the root of the core isopipe. The glass laminate 10 can pass through several thermal zones for sheet shape and stress management and is then cut at the bottom of the draw. The resulting flat glass laminate 10 can be further processed to have a 3D shape for applications such as handheld device and display cover glass. It is noted that the cladding layers 12 might not be the outermost layers of the finished laminate, in some instances.

In various embodiments, the cladding layers 12 may be thermally fused directly to opposing sides of the core layer 14. The glass laminate 10 may be cut to form a glass article, such as a strengthened glass laminate cover, as discussed below.

A thickness of the glass laminate 10 can be measured as the distance between opposing outer surfaces of the glass laminate. In some embodiments, glass laminate 10 may have a thickness of at least about 0.1 mm, at least about 0.5 mm, at least about 1.0 mm, at least about 2 mm, or at least about 3 mm. Additionally, or alternatively, glass laminate 10 may have a thickness of at most about 10 mm, at most about 5 mm, at most about 4 mm, at most about 3 mm, or at most about 2 mm. For example, the glass laminate 10 may have a thickness of from about 0.2 mm to about 5 mm, from about 1 mm to about 5 mm, or from about 1.5 mm to about 4 mm.

In some embodiments, a ratio of a thickness of core layer 14 to a thickness of glass laminate 10 is at least about 0.7, at least about 0.8, at least about 0.85, at least about 0.9, or at least about 0.95. Additionally, or alternatively, the ratio of the thickness of the core layer 14 to the thickness of the glass laminate 10 is at most about 0.95, at most about 0.93, at most about 0.9, at most about 0.87, or at most about 0.85. In some embodiments, a thickness of one or each of the cladding layers 12 is from about 0.01 mm to about 0.3 mm. In some embodiments, each of the cladding layers 12 is thinner than the core layer 14.

In some embodiments, a glass composition of the cladding layers 12 comprises a different average coefficient of thermal expansion (CTE) than a glass composition of the core layer 14. For example, the cladding layers 12 may be formed from a glass composition having a lower average CTE than the core layer 14. The CTE mismatch (i.e., the difference between the average CTE of the cladding layers 12 and the average CTE of the core layer 14) results in formation of compressive stress in the cladding layers 12 and tensile stress in the core layer 14 upon cooling of glass laminate 10. As used herein, the term “average coefficient of thermal expansion,” or “average CTE,” refers to the average coefficient of linear thermal expansion of a given material or layer between 0° C. and 300° C. As used herein, the term “coefficient of thermal expansion,” or “CTE,” refers to the average coefficient of thermal expansion unless otherwise indicated. The CTE can be determined, for example, using the procedure described in ASTM E228 “Standard Test Method for Linear Thermal Expansion of Solid Materials With a Push-Rod Dilatometer” or ISO 7991:1987 “Glass—Determination of coefficient of mean linear thermal expansion.”

In some embodiments, the CTE of the core layer 14 and the CTE of the cladding layers 12 differ by at least about 1×10⁻⁷° C.⁻¹, at least about 2×10⁻⁷° C.⁻¹, at least about 3×10⁻⁷° C.⁻¹, at least about 4×10⁻⁷° C.⁻¹, at least about 5×10⁻⁷° C.⁻¹, at least about 10×10⁻⁷° C.⁻¹, at least about 15×10⁻⁷° C.⁻¹, at least about 20×10⁻⁷° C.⁻¹, at least about 25×10⁻⁷° C.⁻¹, at least about 30×10⁻⁷° C.⁻¹, at least about 35×10⁻⁷° C.⁻¹, at least about 40×10⁻⁷° C.⁻¹, or at least about 45×10⁷° C. Additionally, or alternatively, the CTE of the core layer 14 and the CTE of the cladding layers 12 differ by at most about 100×10⁻⁷° C.⁻¹, at most about 75×10⁻⁷° C.⁻¹, at most about 50×10⁻⁷° C.⁻¹, at most about 40×10⁻⁷° C.⁻¹, at most about 30×10⁻⁷° C.⁻¹, at most about 20×10⁻⁷° C.⁻¹, at most about 10×10⁻⁷° C.⁻¹, at most about 9×10⁻⁷° C.⁻¹, at most about 8×10⁻⁷° C.⁻¹, at most about 7×10⁻⁷° C.⁻¹, at most about 6×10⁻⁷° C.⁻¹, or at most about 5×10⁷° C. For example, in some embodiments, the CTE of the core layer 14 and the CTE of the cladding layers 12 differ by about 1×10⁷° C.⁻¹ to about 10×10⁷° C.⁻¹ or about 1×10⁷° C.⁻¹ to about 5×10⁷° C.⁻¹. In some embodiments, the cladding layers 12 comprise a CTE of at most about 90×10⁻⁷° C.⁻¹, at most about 89×10⁻⁷° C.⁻¹, at most about 88×10⁻⁷° C.⁻¹, at most about 80×10⁻⁷° C.⁻¹, at most about 70×10⁻⁷° C.⁻¹, at most about 60×10⁻⁷° C.⁻¹, at most about 50×10⁻⁷° C.⁻¹, at most about 40×10⁻⁷° C.⁻¹, or at most about 35×10⁷° C.⁻¹. Additionally, or alternatively, the cladding layers 12 comprise a CTE of at least about 10×10⁻⁷° C.⁻¹, at least about 15×10⁻⁷° C.⁻¹, at least about 25×10⁻⁷° C.⁻¹, at least about 30×10⁻⁷° C.⁻¹, at least about 40×10⁻⁷° C.⁻¹, at least about 50×10⁻⁷° C.⁻¹, at least about 60×10⁻⁷° C.⁻¹, at least about 70×10⁻⁷° C.⁻¹, at least about 80×10⁻⁷° C.⁻¹, or at least about 85×10⁷° C.⁻¹. Additionally, or alternatively, the core layer 14 comprises a CTE of at least about 40×10⁻⁷° C.⁻¹, at least about 50×10⁻⁷° C.⁻¹, at least about 55×10⁻⁷° C.⁻¹, at least about 65×10⁻⁷° C.⁻¹, at least about 70×10⁻⁷° C.⁻¹, at least about 80×10⁻⁷° C.⁻¹, or at least about 90×10⁷° C.⁻¹. Additionally, or alternatively, the core layer 14 comprises a CTE of at most about 120×10⁻⁷° C.⁻¹, at most about 110×10⁻⁷° C.⁻¹, at most about 100×10⁻⁷° C.⁻¹, at most about 90×10⁻⁷° C.⁻¹, at most about 75×10⁻⁷° C.⁻¹, or at most about 70×10⁷° C.⁻¹.

In various embodiments, the relative thicknesses of the glass layers can be selected to achieve a glass article having desired strength properties. For example, in some embodiments, the glass compositions of the core layer 14 and the cladding layers 12 are selected to achieve a desired CTE mismatch, and the relative thicknesses of the glass layers are selected, in combination with the desired CTE mismatch, to achieve a desired compressive stress in the cladding layers and tensile stress in the core layer.

Without wishing to be bound by any theory, it is believed that the strength profile of the glass article can be determined predominantly by the relative thicknesses of the glass layers and the compressive stress in the cladding layers, and that the breakage pattern of the glass article can be determined predominantly by the relative thicknesses of the glass layers and the tensile stress in the core layer. Thus, the glass compositions and relative thicknesses of the glass layers can be selected to achieve a glass article having a desired strength profile and/or breakage pattern. The glass article can have the desired strength profile and/or breakage pattern in an as-formed condition without additional processing (e.g., thermal tempering or ion-exchange treatment).

In some embodiments, the compressive stress of the cladding layers 12 is at most about 800 MPa, at most about 500 MPa, at most about 350 MPa, or at most about 150 MPa. Additionally, or alternatively, the compressive stress of the cladding layers 12 is at least about 10 MPa, at least about 20 MPa, at least about 30 MPa, at least about 50 MPa, or at least about 250 MPa. Additionally, or alternatively, the tensile stress of the core layer 14 is at most about 150 MPa, or at most about 100 MPa. Additionally, or alternatively, the tensile stress of the core layer 14 is at least about 5 MPa, at least about 10 MPa, at least about 25 MPa, or at least about 50 MPa.

In some embodiments, the core layer 14 may be formed of a glass material such as, for example, Corning® Gorilla® Glass. Additionally, or alternatively, the cladding layers 12 may be formed of a glass material such as, for example, Corning® EagleXG™ Glass.

According to various embodiments, provided is a workstation including a horizontally aligned work surface in which a display is embedded and covered with a strengthened glass laminate. In some embodiments, the workstation may be in the form of a workbench. In other embodiments, the workstation may be configured as a countertop and/or may optionally be integrated into cabinetry.

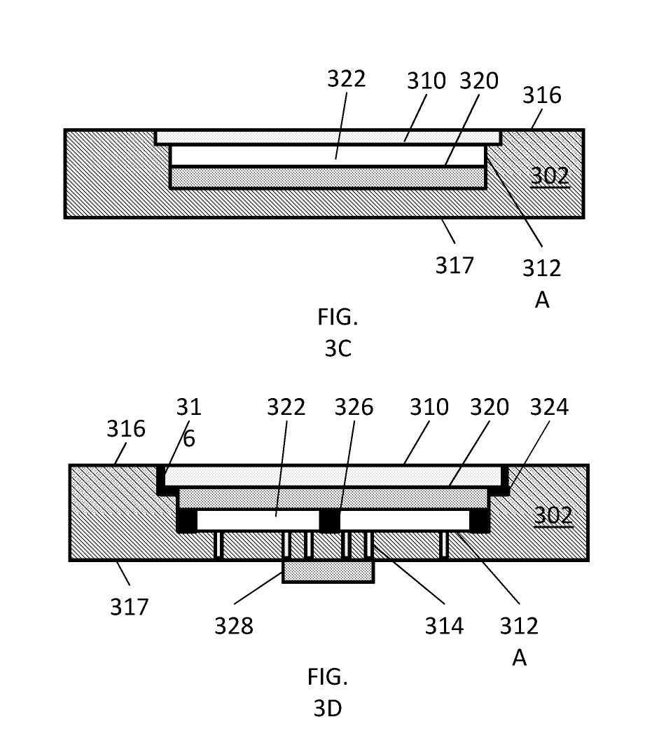

FIG. 3A is a perspective view of a workstation 300, according to various embodiments of the present disclosure. FIG. 3B is a sectional view taken along line A of FIG. 3A. Referring to FIGS. 3A and 3B, the workstation 300 may include a substantially horizontally aligned work surface 302, supports 304 supporting the work surface 302, a display 320 embedded in the work surface 302, and a strengthened glass laminate cover 310 disposed over the display 320. The workstation 300 may optionally include a backsplash 306 and/or a wiring conduit 308. The cover 310 may be formed from the glass laminate 10.

The work surface 302 and/or backsplash 306 may be configured to resist heat, corrosive materials, impacts, or the like. For example, the work surface 302 and/or backsplash 306 may be formed of stone, stainless steel, ceramic, concrete, or the like. The supports 304 may be formed of the same material or a different material, so long as the supports 304 have sufficient strength to support the work surface 302.

The display 320 may be disposed in a recess 312 formed in the work surface 302. For example, the work surface 302 comprises an upper surface 316, a lower surface 317 opposite the upper surface, and the recess 312 extends into the work surface from the upper surface toward the lower surface. In some embodiments, the recess 312 extends only partially through the work surface 302 such that the recess does not extend to the lower surface 317 as shown in FIG. 3C. In other embodiments, the recess 312 extends entirely through the work surface 302 such that the recess extends to and through the lower surface 317 as shown in FIGS. 3B and 3C. The work surface 302 may include one or more through holes 314 formed at the bottom of the recess 312 to provide ventilation for cooling the display 320. The through holes 314 may extend from the recess 312 toward the lower surface 317 of the work surface 302. The through holes 314 may extend only partially to the lower surface 317 or to the lower surface. The display 320 may be a commercially available flat panel display device, such as an LCD, LED, OLED, plasma, electrochromic display device, or the like. The display 320 may be connected to a processing unit such as a computer or server. In other embodiments, the display 320 may be a tablet computer or another computing device. The display 320 may include touch screen functionality.

The workstation 300 may optionally include wiring 330 to connect the display 320 to the wiring conduit 308. The wiring 330 may be run through or below the work surface 302, according to various embodiments. The wiring 330 and/or wiring conduit 308 may include electrical wiring to provide power to the display 320, wiring for connection to the Internet, such as Ethernet cabling, and/or wiring for relaying audio and/or visual signals from an external source, such as an HDMI cable or the like. In some embodiments, the wiring 330 and wiring conduit 308 may operate to connect the display 320 to other devices disposed on the bench 300, such that the display 320 may be used to control the same. In other embodiments, the wiring conduit 308 and/or the wiring 330 may be omitted, the display 320 may wirelessly connect to devices on or adjacent to the workstation 300. In the alternative, the wiring conduit 308 may be omitted and the wiring 330 may be disposed under the work surface 302.

The workstation 300 may also optionally include a sensor 332 electrically connected to the display 320 and/or the wiring conduit 308. The sensor 332 may include an optical sensor configured to enable hands free operation of the display 320, such as a camera to enable the display to be operated by gesture commands. The sensor 332 may include a microphone to enable the display 320 to be operated by voice commands, or another sensing device configured to detect commands to operate the display and/or other components (e.g., a computer or a laboratory instrument) operatively connected to the display.

The cover 310 may be disposed in the recess 312, so as to cover the display device 320. The cover 310 may be flush with with the upper surface of the work surface 302 and/or side surfaces of the recess 312. For example, the cover 310 and the upper surface of the work surface 302 may form a substantially continuous surface. In some embodiments, the cover 310 may be disposed directly on the display 320. For example, the cover 310 may be coupled to the display 320 (e.g., with an adhesive). Upper surfaces of the cover 310 and the display 320 may have substantially the same surface area. The cover 310 may comprise a strengthened fused glass laminate, as described above with regard to FIGS. 1 and 2. Accordingly, the cover 310 may be relatively thin, as compared to conventional glass covers. For example, the cover 310 may have a thickness ranging from about 2 to about 10 mm, such as a thickness ranging from about 3 to about 7 mm, or from about 4 to about 6 mm

The use of the strengthened fused glass laminate as a material of the cover 310 may enable the cover to have a thickness that is less than that of a conventional cover, while still providing high impact and scratch resistance. As such, the cover 310 may provide improved response with regard to the use of a touch screen functionality of the display device 320. Further, the cover 310 may have comparatively low amounts of optical distortion and/or attenuation. The cover 310 may also be precisely manufactured to specific tolerances designed to match the dimensions of the recess 312.

Finally, the laminate structure of the cover 310 provides improved durability with respect to being heated and cooled. For example, tempered glass covers rely on a temperature gradient established within the glass cover followed by controlled cooling during forming to generate compressive stress at the outer surfaces. Heating and subsequent cooling of the tempered glass cover can reduce or eliminate the compressive stress by enabling relaxation within the glass matrix, thus reducing the strength of the tempered glass cover. Similarly, chemically strengthened glass covers rely on replacement of relatively small ions within the glass matrix near the surface of the glass cover with relatively large ions in an ion exchange medium during forming to cause crowding of the glass matrix near the surface and generate compressive stress near the surface. Heating and subsequent cooling of the chemically strengthened glass cover can reduce or eliminate the compressive stress by enabling ion diffusion within the glass matrix, thus reducing the strength of the chemically strengthened glass cover. In contrast, strengthened glass laminate covers rely, at least partially, on the CTE mismatch between the core layer and the cladding layers to generate compressive stress in the cladding layers. Heating the strengthened glass laminate can cause the compressive stress in the cladding layers to decrease, but the compressive stress in the cladding layers returns to approximately its original level upon subsequent cooling of the strengthened glass laminate. Thus, the strength of the strengthened glass laminate cover is maintained even after repeated heating and cooling.

FIG. 3C is a sectional view of a modified version of the workstation 300, taken along line A of FIG. 3A, according to another exemplary embodiment of the present disclosure. Since the embodiment of FIG. 3C is similar to the embodiment of FIG. 3B, only the differences therebetween will be discussed in detail.

Referring to FIGS. 3A and 3C, the work surface 302 includes a stepped recess 312A. The cover 310 may be disposed on the stepped portion of the recess 312A, such that the cover is separated from the display 320 by an air gap 322. The air gap 322 may operate to reduce heat transmittance between the cover 310 and the display 320. In some embodiments, the upper surface of the cover 310 has a larger area than an upper surface of the display 320.

FIG. 3D is a sectional view of a modified version of the workstation 300, taken along line A of FIG. 3A, according to another exemplary embodiment of the present disclosure. Since the embodiment of FIG. 3D is similar to the embodiment of FIG. 3C, only the differences therebetween will be discussed in detail.

Referring to FIGS. 3A and 3D, the work surface 302 includes a stepped recess 312A. The cover 310 may be disposed on the stepped portion of the recess 312. A seal 324 may be disposed between the cover 310 and the work surface 302. The seal 324 may be configured to protect edges of the cover 310 and/or to fill any space between edges of the cover 310 and the work surface 302. In some embodiments, the seal 324 may be formed of a silicone-based material, or the like.

The workstation 300 may include one or more spacers 326 between the display 320 and the bottom of the recess 312A, such that an air gap 322 is formed between the bottom of the display 310 and the bottom of the recess 312A. The spacers 326 may position the display 320 against the cover 310 and may be formed of an elastic material such as rubber or plastic. As such, the spacers 326 allow for the inclusion of displays of different thicknesses. The spacers may also allow for the alignment of the display 320 to be changed. For example, the display 320 may be disposed at an angle within the recess 312A by using spacers 326 of different heights.

The work surface 302 may also include through holes 314 in the bottom of the recess 312A. The workstation 300 may also include a fan 328 configured to circulate air between the air gap 322 and the ambient environment.

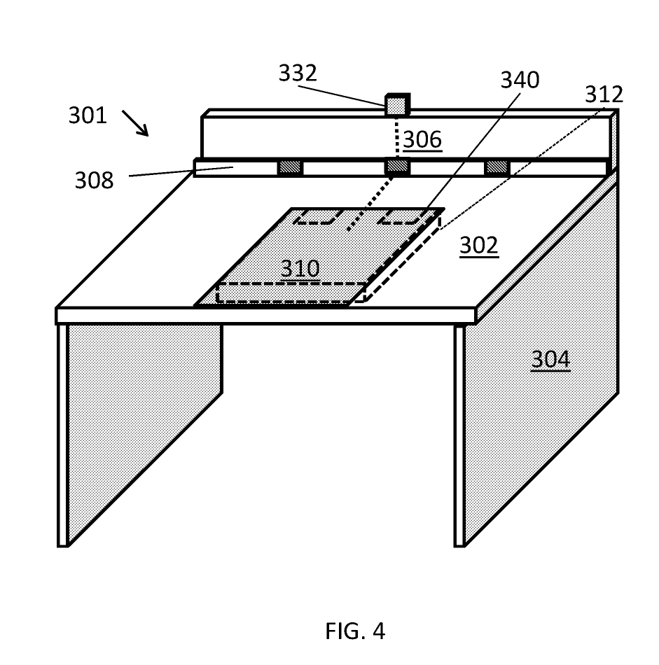

FIG. 4 is a perspective view of a modified workstation 301, according to various embodiments of the present disclosure. The workstation 301 is similar to the workstation 300 of FIG. 3A, so only the differences therebetween will be discussed in detail. In addition, the configurations shown in FIGS. 3B-3D are also applicable to the workstation 301.

Referring to FIG. 4, the workstation 301 may include hinges 340 attached to the cover 310 and a sidewall of the recess 312. Accordingly, the cover 310 may be pivoted on the hinges 340 to allow access to the recess 312. The cover 310 may also extend to, or slightly past and edge of the work surface 302, such that the edge of the cover 310 may be easily accessible.

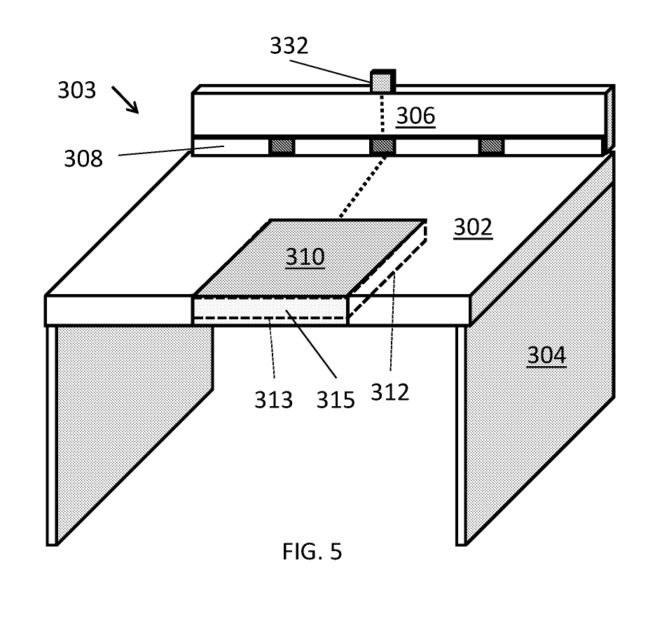

FIG. 5 is a perspective view of a modified workstation 303, according to various embodiments of the present disclosure. The workstation 303 is similar to the workstation 300 of FIG. 3A, so only the differences therebetween will be discussed in detail. In addition, the configurations shown in FIGS. 3B-3D are also applicable to the workstation 303.

Referring to FIG. 5, the cover 310 and the recess 312 may be disposed adjacent to an edge of the work surface 302. For example, the recess 312 may form an opening 313 at the edge of the work surface 302, which may allow for access to a display device disposed in the recess 312, without removal of the cover 310. In some embodiments, the workstation may include a door 315 covering the opening 313. The door 315 may include vents or a fan to release heat from the recess 312.

While various the cover and recess are shown in the above exemplary embodiments in various locations, the present disclosure is not limited to any particular locations for these elements in the work surface. For example, in some embodiments, the cover and recess may be disposed anywhere on the work surface. In addition, the cover and recess are not limited to any particular size or shape. For example, the cover and recess may be substantially the same size as the work surface. For example, the cover could entirely cover the upper surface of the work surface, in some embodiments.

It will be apparent to those skilled in the art that various modifications and variations can be made without departing from the spirit or scope of the invention. For example, the features of FIGS. 3B-3D may be used in any combination. Accordingly, the invention is not to be restricted except in light of the attached claims and their equivalents.

1. A workstation comprising:
a substantially horizontally aligned work surface comprising a recess formed in an upper surface thereof and configured to receive a display; and
a strengthened glass laminate cover disposed in the recess and comprising:
a glass core layer; and
first and second glass cladding layers fused to opposing first and second sides of the core layer.

2. The workstation of claim 1, wherein each of the first and second cladding layers has a lower coefficient of thermal expansion (CTE) than the core layer.

3. The workstation of claim 1, further comprising a seal disposed between edges of the cover and sidewalls of the recess.

4. The workstation of claim 1, wherein the cover is disposed on a stepped portion of the recess.

5. The workstation of claim 1, wherein the work surface comprises through holes extending from the recess toward a lower surface of the work surface.

6. The workstation of claim 5, further comprising a fan configured to move air through the through holes.

7. The workstation of claim 1, wherein the cover is flush with the upper surface of the work surface.

8. The workstation of claim 1, further comprising:
a wiring conduit disposed on the work surface; and
wiring configured to electrically connect the display to the wiring conduit.

9. The workstation of claim 8, wherein the wiring extends through the work surface from the recess to the wiring conduit.

10. The workstation of claim 8, wherein at least a portion of the wiring extends under the work surface from the recess to the wiring conduit.

11. The workstation of claim 1, wherein the cover is connected to the work surface with one or more hinges.

12. The workstation of claim 1, further comprising one or more supports configured to support the work surface.

13. The workstation of claim 1, wherein the work surface comprises an opening formed in an edge thereof to allow access to the recess.

14. The workstation of claim 1, further comprising a display disposed within the recess.

15. The workstation of claim 14, wherein the cover is coupled to the display.

16. The workstation of claim 14, wherein the cover is separated from the display by a gap.

17. The workstation of claim 14, wherein the display is separated from a bottom of the recess by a gap.

18. The workstation of claim 14, further comprising spacers disposed between the bottom of the recess and the display.

19. The workstation of claim 14, further comprising a sensor electrically connected to the display and configured to detect motion, sound, or a combination thereof.

20. The workstation of claim 14, wherein the display comprises a tablet computer or a flat panel display.

21. A workstation comprising:
a substantially horizontally aligned work surface comprising a recess formed in an upper surface thereof;
one or more supports configured to support the work surface;
a display disposed within the recess and configured to display images; and
a strengthened glass laminate cover disposed in the recess flush with the work surface and having a thickness of 6 mm or less, the cover comprising:
a glass core layer; and
first and second glass cladding layers fused directly to opposing first and second sides of the core layer, each of the first and second cladding layers having a lower coefficient of thermal expansion (CTE) than the core layer.
